(19) United States
(12) Patent Application Publication
(10) Pub. No.: US 2015/0178438 A1
(43) Pub. Date: Jun. 25, 2015

(54) SEMICONDUCTOR MANUFACTURING USING DESIGN VERIFICATION WITH MARKERS

(71) Applicants: ERTUGRUL DEMIRCAN, Austin, TX (US); Douglas M. Reber, Austin, TX (US); Michael A. Stockinger, Austin, TX (US); Edward O. Travis, Austin, TX (US)

(72) Inventors: ERTUGRUL DEMIRCAN, Austin, TX (US); Douglas M. Reber, Austin, TX (US); Michael A. Stockinger, Austin, TX (US); Edward O. Travis, Austin, TX (US)

(21) Appl. No.: 14/137,530

(22) Filed: Dec. 20, 2013

(51) Int. Cl. G06F 17/50

(52) U.S. Cl. CPC G06F 17/5081

(57) ABSTRACT

A first circuit design is entered in an electronic design automation (EDA) computer system. The first circuit design includes a first feature with a first node. A marker is associated with the first node and represents a voltage associated with the first node as an algebraic expression of a numerical value representing a property of the circuit design. The marker is used to determine if the component of the circuit design violates a design rule.

### BACKGROUND

1. Field

This disclosure relates generally to semiconductor manufacturing, and more specifically, semiconductor manufacturing that uses design verification with markers.

2. Related Art

Semiconductor manufacturing involves a great number of transistors that function together. The totality of the functions and the great number of transistors make it unrealistic to completely model operation of a particular integrated circuit under all conditions. The design is typically done in modules that are then connected together. Thus the modules must work together which implies a functional interface. The circuits also desirably can be reused in different integrated circuits that may utilize different processes and different power supply voltages. Integrated circuits, especially ones with non-volatile memory (NVM), can have several different power supply voltage and the difference can span an order of magnitude. These circuits must be able to work together.

Accordingly there is a need to provide further improvement in achieving verification of integrated circuits that may include circuits that my subject to different power supply voltages.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a first layout of a circuit having a first set of fixed voltages;

FIG. 2 is a second layout of the circuit having a second set of fixed voltages in which the first set is not the same as the second set;

FIG. 3 is a flow diagram of a method of making an integrated circuit; and

FIG. 4 is a system of making an integrated circuit according to the method of FIG. 3.

### DETAILED DESCRIPTION

In one aspect, a design of a circuit includes providing markers for nodes of the circuit. Each marker provides a voltage that is an algebraic expression of fixed voltages that the circuit will receive. The markers are then used to verify that the layout of the circuit is proper for both an initial design and a subsequent design in which one or more voltages that the circuit will receive change from the initial design. This is better understood by reference to the drawings and the following written description.

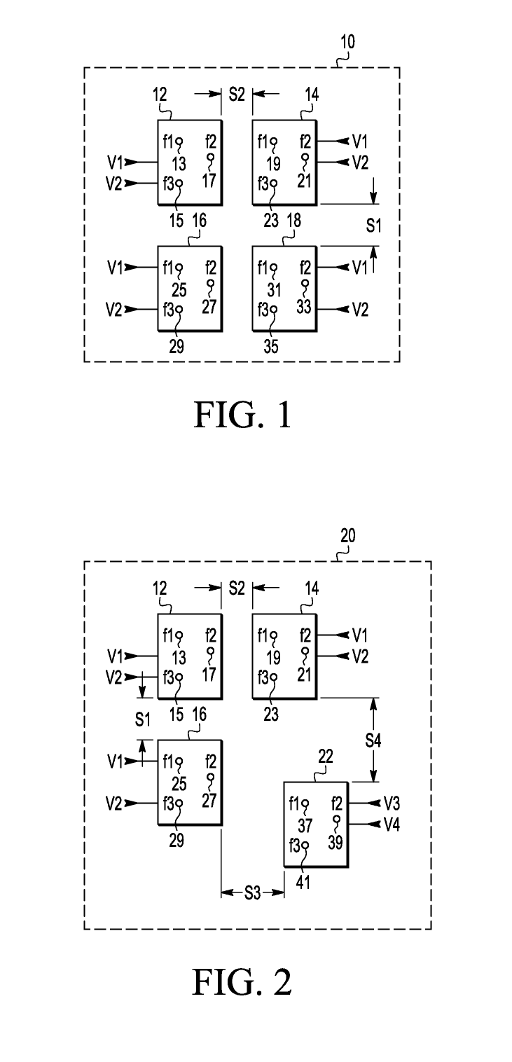

Shown in FIG. 1 is a circuit 10 comprising a feature 12, a feature 14, a feature 16, and a feature 18. Features 12, 14, 16, and 18 are features that may be different or the same and that may be found on an integrated circuit. Examples include a conductive line, a via, a well, a source/drain, a transistor, a circuit element, a combination of transistors, and a functional circuit that each receive a voltage V1 and a voltage V2. In a specific example that will be described in more detail, features 12, 14, 16, and 18 are circuit elements and may be referenced as circuit elements 12, 14, 16, and 18. They could also be referenced as one of the other possible examples such as conductive lines 12, 14, 16, and 18; wells 12, 14, 16, and 18; or vias 12, 14, 16, and 18, etc. Voltages V1 and V2 are input voltages to circuit elements 12, 14, 16, and 18. Connections among circuit elements 12, 14, 16, and 18 are not shown. Circuit element 12 has nodes 13, 15, and 17. Circuit element 14 has nodes 19, 21, and 23. Circuit element 16 has nodes 25, 27, and 29. Circuit element 18 has nodes 31, 33, and 35. Voltages V1 and V2 may be fixed voltages which do not change over time. Voltages V1 and V2 may each be one of a power supply voltage and a characteristic voltage of a signal. A characteristic voltage of a signal may be the maximum voltage of the signal, the minimum voltage of the signal, the average voltage of the signal, or the root mean square (RMS) voltage of the signal representing the average power of a signal. For example, a signal that provides a logic output, such as a logic high, will provide that logic high at a predictable level, which is the maximum signal level, and which is known in advance. It is the maximum voltage of a signal that is normally of concern in terms of the ability of the signal to be safely handled by the circuit receiving the signal. It is the voltage at the extreme of a signal that is most often the voltage of concern. However, a different characteristic than the extreme voltage may be of concern and may be chosen for layout check. Because it is known in advance what the voltage of concern is, its numerical value is particularly useful in representing a property of the circuit design. Although voltage may be the most straightforward property of a circuit design for use in obtaining a marker, there may be other properties of the circuit which can be used in obtaining a marker such as current that flows through a branch of the circuit or the frequency bandwidth of a signal.

Each of circuit elements 12, 14, 16, and 18 has markers f1, f2, and f3. Each marker is for a particular node of the circuit element and provides a calculated voltage associated with that node based on other voltages that are properties of the circuit design. Thus nodes, which may be all of the nodes or selected nodes, of the circuit elements have associated markers. Marker f1 of circuit element 12 is associated with node 13. Marker f2 of circuit element 12 is associated with node 15. Marker f3 of circuit element 12 is associated with node 17. Similarly, markers f1, f2, and f3 of circuit element 14 are associated with nodes 19, 21, and 23, respectively. Markers f1, f2, and f3 of circuit element 18 are associated with nodes 25, 27, and 29, respectively. Markers f1, f2, and f3 of circuit element 18 are associated with nodes 31, 33, and 35, respectively.

Each of markers f1, f2, and f3 is expressed as an algebraic expression of, in this example, fixed voltages V1 and V2 which are each an example of a property of the circuit design that relates to features 12, 14, 16, and 18. The calculation of the algebraic expression of the marker results in a marker voltage for the node that the particular marker is associated with. The marker voltage may represent a potentially problematic voltage that will occur at the node that the marker is associated with such as a maximum voltage or a minimum voltage that will occur at that node. The algebraic expression for functions of any of the markers f1, f2, and f3 can simply be a multiplier, which may be either greater or less than one, of one of the voltages V1 and V2, for example 2×V1 or V2/2. Also the function can include some combination of the voltages V1 and V2, for example V1+V2, (V1+V2)/2, or (V1×V2)/(V1+V2). The function can also be expressed as an alternative of V1 and V2, for example, the function could be “the greater of 0.5×V1 or 1.1×V2.” Thus the function can be linear or non-linear. The possibilities are essentially limitless and are chosen for accuracy in calculating the marker voltage. Thus, marker f1, for example, may be shown as f1(V1, V2). Similarly, marker f2 may be shown as f2(V1, V2) and marker f3 as f3(V1, V2). Although only V1 and V2 are shown as the properties of the circuit design used in the algebraic expressions for calculating the marker voltages, the algebraic expressions may also relate to a different property than voltage which may be, for example, current. In this example, circuit elements 12, 14, 16, and 18 have three nodes in which each is associated with a different one of functions of markers f1, f2, and f3. In this example, circuit elements 12, 14, 16, and 18 are the same which implies that f1, for example, for each of the circuit elements is the same. On the other hand, however, simply because the marker functions are the same does not mean that circuits are the same because many nodes are likely to have the same marker. There may be many more nodes than those shown and with other functions. Also, a given marker function may have a property of the circuit design as an input, such as a maximum voltage which is common to other circuits, but the given marker function may use a different algebraic expression. Thus for a case where circuit elements are different, a first of the circuit elements may have a marker with a particular input voltage using a first algebraic expression and a second of the circuit elements may have a marker with the same input voltage as the first marker using a second algebraic expression different from the first algebraic expression. Examples of nodes include a sub-circuit pin, a terminal, a location on a connection between two source/drains, or a location on a conductive line. A marker may be copied to nodes that are connected to the same node as the marker is associated with.

In this example of the circuit elements 12, 14, 16, and 18 being the same shape, having the same markers, and receiving the same voltages, they can be spaced apart by the same amount, S1 in the vertical direction and S2 in the horizontal direction. This is as expected in such case where there is symmetry of the circuit elements. This kind of symmetry allows for symmetric layout. What is less apparent is that the applied voltages, if different, can result in problems with a symmetric layout. The determination of such a problem can be difficult to find, especially if the symmetric layout has been replicated successfully in the past in situations where the applied voltages were the same.

Shown in FIG. 2 is a circuit 20 having circuit elements 12, 14, and 16 of FIG. 1 and a circuit element 22 that has nodes 37, 39, and 41 and that is identical to and displaces circuit element 18 of FIG. 1. Markers f1, f2, and f3 of circuit element 22 are associated with nodes 37, 39, and 41, respectively. Circuit element 22 receives fixed voltages V3 and V4 which are different than fixed voltages V1 and V2, but circuit element 22 has the same markers, f1, f2, and f3, as circuit element 18. Due to the different voltages, however, the calculation of functions f1, f2, and f3 has different results. These different results require moving circuit element 22 further away from circuit elements 12, 14, and 16. The result is that circuit element 22 is spaced vertically from circuit element 14 by space S4 which is greater than space S1. Similarly, circuit element 22 is spaced horizontally from circuit element 16 by a space S3 that is greater than space S2. This difference in marker voltages is the desired result which is easily obtained by having the functional description of the markers so that the recognition of the difference in the required placement of circuit element 22 relative to other circuit elements is both easily recognized but also quantified. In such case it is relatively simple to determine if a design rule would be violated if circuit element 22 were placed in the same location as circuit element 18 relative to circuit elements 12, 14, and 16.

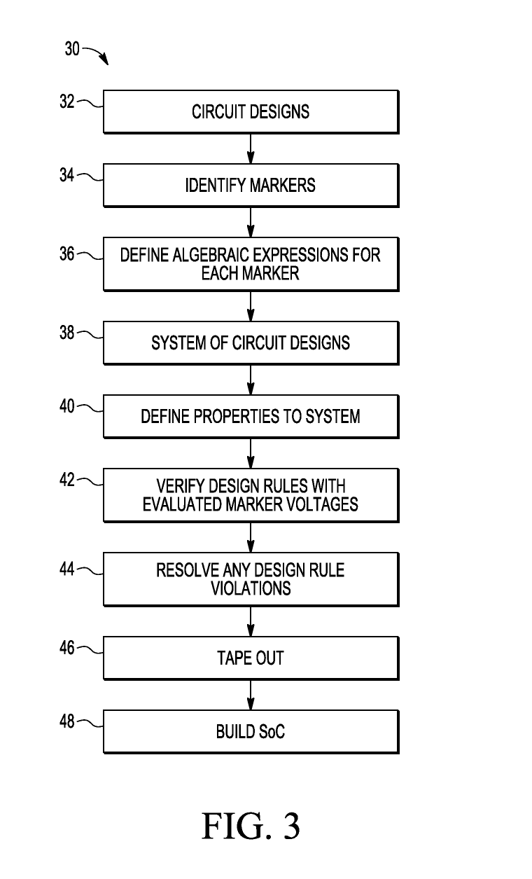

Shown in FIG. 3 is a method 30 that begins with circuit designs, step 32, which may include circuit 10 or circuit 20. After the design is complete, all of the marker locations are identified as shown in step 34. For each marker, an algebraic expression is based on properties of the circuit design as shown in step 36. For example, marker f1 of feature 22, which is circuit element 22 as shown in FIG. 2, corresponds to node 37 and has a calculated value using an algebraic expression that in turn uses voltages V3 and V4 as inputs. In this case voltages V3 and V4 are properties of the circuit design which have the predictable influence, using the algebraic expression for marker f1, on the voltage at node 37. A system is then pieced together, as shown in step 38, using the circuit designs. The various properties of the circuit designs to be used by the system are then defined and applied to the system design as shown in step 40. Compliance to the design rules is then verified as shown in step 42. In the event of a design rule violation being detected, an appropriate adjustment, which may be a layout change, will be implemented to overcome the design rule violation as shown in step 44. This may result in a change such as that shown in the change from circuit 10 of FIG. 1 to circuit 20 of FIG. 2. In that example, the input voltages changed for one of the circuits resulting in a design rule violation that was fixed by spacing the circuit element that had the input voltage change further from the other circuit elements. For example, an increase in voltages V1 and V2 may have resulted in the calculation of marker f1 resulting in a sufficiently high voltage for node 37 that circuit element 22 needed to be moved a distance S4 from circuit element 14 and a distance S3 from circuit element 16. Of course, the calculations for markers f2 and f3 may have been a cause of the spacing increase as well. When different circuits, which have been designed by different teams, are stitched together, there can be differences not fully anticipated at the interface. By having the markers be an algebraic expression of the properties of the circuit design, the rules violations are readily identified and feasibility of different possible fixes is readily determined. After the rule violations are addressed, the system is tested again to verify that the design rules are met using the evaluated marker voltages as shown in step 42 and perhaps further adjusted until any design rule violations are resolved. Once this verification is achieved, tapeout as shown in step 46 is performed. After tapeout, manufacturing can begin as shown as building a system on a chip (SoC) as shown in step 48.

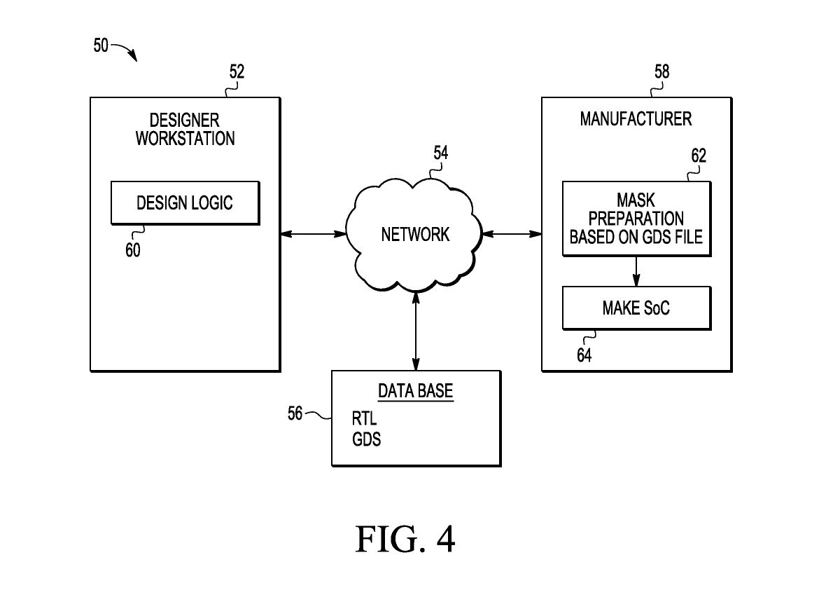

Shown in FIG. 4 is a system 50 for implementing method 30 of FIG. 3. System 50 includes a designer work station 52 connected to a network 54, a data base 56 connected to network 54, and a manufacturer 58 coupled to network 54. Design logic 60 arises from using designer work station 52. In addition though, designer work station 52 is used to perform all of the steps of method 30 through resolving any design rule violations of step 44. Work station 52 includes a tangible computer storage medium including circuit layout files which is readable by an electronic design automation computer system and includes a circuit design having circuit components with nodes and markers associated with certain nodes. For example, a circuit schematic file is on the tangible computer storage medium, the circuit layout file is based on a circuit schematic file, and the schematic file includes the markers associated with the node. Network 54 and data base 56 are used together to produce the final tapeout having the register-transfer level (RTL) and the graphic data system (GDS). The GDS is then sent to manufacturer 58 through network 54. Manufacturer 58 does mask preparation 62 based on the GDS. From the mask, the manufacturer, as shown at a step 64, makes the SoC.

Thus it is shown that an enhanced marker system, which uses functions relative to fixed voltages, can be used in semiconductor manufacturing to efficiently identify rule violations, efficiently make fixes, and perform manufacturing.

By now it should be appreciated that there has been provided a method including entering a first circuit design in an electronic design automation (EDA) computer system, wherein the first circuit design includes a first feature with a first node. The method further includes providing a marker that represents a voltage associated with the first node as an algebraic expression of a first numerical value, wherein the first numerical value represents a property of the first circuit design. The method further includes using the marker for a determination if the first feature of the first circuit design causes a design rule violation. The method may further include resolving the design rule violation if the determination is that a design rule violation has occurred. The method may have a further characterization by which the resolving the design rule violation comprises increasing spacing between the first feature and a second feature that is adjacent to the first feature. The method may further include manufacturing a system using the first circuit design after resolving the design rule violation. The method may further include supplying the first circuit design to a semiconductor manufacturer to perform the manufacturing. The method may have a further characterization by which the determination if a design rule violation has occurred is based on a spacing between the first feature and a second feature of the first circuit design. The method may have a further characterization by which the first feature comprises one of a group consisting of a conductive line, a via, a well, and a circuit element. The method may have a further characterization by which the first node is one of a group consisting of a terminal, a sub-circuit pin, a location on a well, a location on a conductive line, a location in a circuit element, and a location on a via. The method may further include entering a plurality of circuit designs in addition to the first circuit design in the EDA computer system, each of the plurality of circuit designs including at least one feature with a marker node, associating one of a plurality of markers with the marker node of the at least one feature in each of a respective one of the plurality of circuit designs, each of the markers representing a voltage associated with the marker node as an algebraic function, evaluating voltage levels represented by each of the markers, and using the voltage levels represented by each of the markers to verify design rules in the EDA computer system. The method may further include adjusting the circuit designs if at least one of the circuit designs violates the design rules. The method may have a further characterization by which the marker represents the voltage associated with the first node as a function of the first numerical value representing the first property of the first circuit design and a second numerical value representing a second property of the first circuit design. The method may further include copying the marker associated with the first node to other nodes connected to the first node.

Disclosed also is a method including receiving at least one circuit layout file. The at least one circuit layout includes a circuit design having a first feature that includes a first node, wherein the first feature is spaced from a second feature by a first distance and a marker associated with the first node, wherein the marker represents a voltage which is calculated with an algebraic expression using a numerical representation of a property of the circuit design. The method further includes checking design rules for the circuit design in an electronic design automation (EDA) computer system using the marker to determine if the first distance is in compliance with the design rules. The method may have a further characterization by which the algebraic function is one of a group consisting of: a non-linear function and a linear function. The method may have a further characterization by which the first feature comprises one of a group consisting of a conductive line, a via, a well, and a circuit element. The method may have a further characterization by which the property of the circuit design comprises one of a group consisting of a voltage and a current. The method may further include, if the checking design rules determines that the first distance is adequate, making an integrated circuit using the circuit design and if the checking design rules determines that the first distance is inadequate, modifying the circuit design until a modified circuit design provides adequate.

Also disclosed is an apparatus having a tangible computer storage medium. The tangible computer storage medium includes at least one circuit layout file. The at least one circuit layout file is readable by an electronic design automation (EDA) computer system and includes a circuit design having a feature with a node and a marker associated with the node. The marker specifies a voltage associated with the node calculated with an algebraic expression using a numerical representation of a property of the circuit design. The apparatus may further include at least one circuit schematic file on the tangible computer storage medium, the at least one circuit layout file is based on the at least one circuit schematic file, the at least one schematic file includes the marker associated with the node. The apparatus may have a further characterization by which the feature comprises one of a group consisting of: a conductive line, a via a well, and a circuit element.

Although the invention is described herein with reference to specific embodiments, various modifications and changes can be made without departing from the scope of the present invention as set forth in the claims below. For example, other fixes than moving a circuit element may be used when finding a design rule violation using the markers based on input voltages. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method comprising:
entering a first circuit design in an electronic design automation (EDA) computer system, wherein the first circuit design includes a first feature with a first node;
providing a marker that represents a voltage associated with the first node as an algebraic expression of a first numerical value, wherein the first numerical value represents a property of the first circuit design; and
using the marker for a determination if the first feature of the first circuit design causes a design rule violation.

2. The method of claim 1 further comprising resolving the design rule violation if the determination is that a design rule violation has occurred.

3. The method of claim 2 wherein:
the resolving the design rule violation comprises increasing spacing between the first feature and a second feature that is adjacent to the first feature.

4. The method of claim 1 further comprising manufacturing a system using the first circuit design after resolving the design rule violation.

5. The method of claim 4 further comprising:
supplying the first circuit design to a semiconductor manufacturer to perform the manufacturing.

6. The method of claim 1, wherein the determination if a design rule violation has occurred is based on a spacing between the first feature and a second feature of the first circuit design.

7. The method of claim 1, wherein the first feature comprises one of a group consisting of a conductive line, a via, a well, and a circuit element.

8. The method of claim 1 wherein the first node is one of a group consisting of a terminal, a sub-circuit pin, a location on a well, a location on a conductive line, a location in a circuit element, and a location on a via.

9. The method of claim 1 further comprising:
entering a plurality of circuit designs in addition to the first circuit design in the EDA computer system, each of the plurality of circuit designs including at least one feature with a marker node;
associating one of a plurality of markers with the marker node of the at least one feature in each of a respective one of the plurality of circuit designs, each of the markers representing a voltage associated with the marker node as an algebraic function;
evaluating voltage levels represented by each of the markers; and
using the voltage levels represented by each of the markers to verify design rules in the EDA computer system.

10. The method of claim 9 further comprising:
adjusting the circuit designs if at least one of the circuit designs violates the design rules.

11. The method of claim 1 wherein the marker represents the voltage associated with the first node as a function of the first numerical value representing the first property of the first circuit design and a second numerical value representing a second property of the first circuit design.

12. The method of claim 1 further comprising:
copying the marker associated with the first node to other nodes connected to the first node.

13. A method comprising:
receiving at least one circuit layout file, the at least one circuit layout file includes:
a circuit design having a first feature that includes a first node, wherein the first feature is spaced from a second feature by a first distance;
a marker associated with the first node, wherein the marker represents a voltage which is calculated with an algebraic expression using a numerical representation of a property of the circuit design; and
checking design rules for the circuit design in an electronic design automation (EDA) computer system using the marker to determine if the first distance is in compliance with the design rules.

14. The method of claim 13 wherein the algebraic function is one of a group consisting of: a non-linear function and a linear function.

15. The method of claim 13 wherein the first feature comprises one of a group consisting of a conductive line, a via, a well, and a circuit element.

16. The method of claim 13 wherein the property of the circuit design comprises one of a group consisting of a voltage and a current.

17. The method of claim 13 further comprising:
if the checking design rules determines that the first distance is adequate, making an integrated circuit using the circuit design; and
if the checking design rules determines that the first distance is inadequate, modifying the circuit design until a modified circuit design provides adequate spacing and making an integrated circuit using the modified circuit design.

18. An apparatus comprising:
a tangible computer storage medium including at least one circuit layout file, the at least one circuit layout file is readable by an electronic design automation (EDA) computer system and includes a circuit design having a feature with a node and a marker associated with the node, wherein the marker specifies a voltage associated with the node calculated with an algebraic expression using a numerical representation of a property of the circuit design.

19. The apparatus of claim 18 further comprising:
at least one circuit schematic file on the tangible computer storage medium, the at least one circuit layout file is based on the at least one circuit schematic file, the at least one schematic file includes the marker associated with the node.

20. The apparatus of claim 18 wherein the feature comprises one of a group consisting of: a conductive line, a via, a well, and a circuit element.
